(19) United States
(12) Patent Application Publication
(10) Pub. No.: US 2014/0177688 A1
(43) Pub. Date: Jun. 26, 2014

(54) MODEM WITH EXPANSION MODULE

(71) Applicant: Nai-Chien CHANG, New Taipei City (TW)

(72) Inventor: Nai-Chien CHANG, New Taipei City (TW)

(21) Appl. No.: 14/093,517

(22) Filed: Dec. 2, 2013

(30) Foreign Application Priority Data
Dec. 25, 2012 (TW) 101225082

(51) Int. Cl. H04M 11/06

(52) U.S. Cl. CPC H04M 11/06
USPC 375/222

(57) ABSTRACT

A modem with an expansion module includes a modulation/demodulation module and the expansion module. The modulation/demodulation module is provided to execute modulation and demodulation operations to network signals. The expansion module mainly has a central processing unit, a memory unit, and a signal output port. The memory unit stores an operating system. After the modem is started up, the central processing unit executes the operating system to generate video and audio signals. The modem is externally connected to a display screen via the signal output port, and the video and audio signals are transmitted to the display screen and displayed on the display screen. Accordingly, the modem is used to provide the network connection function for a computer device and also used as a small computer.

### BACKGROUND

1. Technical Field

The present disclosure relates generally to a modem, and more particularly to a modem with an expansion module.

2. Description of Related Art

For many years, the computer is very popular, and even almost each family has at least one computer. For the traditional personal computer, the mother board, the central processing unit (CPU), the random access memory (RAM), the graphic card, the sound card, the heat-dissipating fan, and a plurality of connector are necessary to be installed inside to the traditional PC. Also the outer casing, it is difficult to move and even carry the traditional PC because of a large volume of the traditional PC.

With the breakthrough and development of manufacturing process in the semiconductor industry, the volume of all kinds of electronic components gets smaller and the efficiency thereof gets greater in recent years. Take the PC for an example, the components such as the mother board, the CPU, the memory are improved and designed to get smaller volume, greater efficiency, and better heat dissipation. In addition, the graphic card and the sound care are also directly built in the mother board. Therefore, the concept of mini computer is appeared on the market.

In recent years, it is prosperous to the free license for the operating system, such as Android operating system and Linus operating system so that the users pay nothing in copyright fees. In addition, the Android operating system and Linus operating system are applied to the mini computers because they have lower hardware requirements. Accordingly, the mini computers are cheaper and smaller due to the hardware limitations.

When the user use the mini computer to connect to the Internet, however, the modem is required to connect to the rear-end Internet service provider (ISP). In general, the volume of the modem is far greater than that of the mini computer as well as the network lines are necessary. In addition, it is inconvenient for the user to do well in line arrangement because the mini computer and the modem are supplied power by two separated power sources.

### SUMMARY

An object of the present disclosure is to provide a modem with an expansion module so that the modem is used to provide the network connection function for a computer device and also used as a small computer.

Another object of the present disclosure is to provide a modem with an expansion module so that the modulation/demodulation module of the modem is provided to directly connect to the Internet when the expansion module of the modem executes the operating system.

In order to achieve the above object, a modem with an expansion module is disclosed. The modem comprises:

a first network connector configured to connect to a telephone line, and the modem configured to connect to a telephone socket;

a second network connector configured to connect to a network line, and the modem configured to connect to a computer device via the network line;

a modulation/demodulation module electrically connected to the first network connector and the second network connector, and configured to execute digital and analog conversions and modulation and demodulation operations to network signals; and

an expansion module electrically connected to the modulation/demodulation module, comprising:

a memory unit configured to store an operating system;

a central processing unit electrically connected to the modulation/demodulation module and the memory unit, and configured to execute the operating system after the modem is started up;

a signal output port electrically connected to the central processing unit, and the modem electrically connected to an external display screen via the signal output port; and the signal output port configured to output video and audio signals generated by executing the operating system to the display screen and displayed on the display screen;

a power connector electrically connected to the central processing unit, and the modem connected to a commercial power via the power connector to receive the required power from the commercial power; and

a switch unit electrically connected to the central processing unit and configured to receive an external trigger to start up the modem;

wherein the expansion module is connected to the modulation/demodulation module to connect to the Internet via the modulation/demodulation module when the central processing unit is configured to execute the operating system.

The modem further comprises:

a first connector electrically connected to the central processing unit, and the modem is externally connected to an input device via the first connector; wherein the input device is configured to execute the operating system of the expansion module.

The first connector is a USB connector, a mini USB connector, or a micro USB connector.

The modem further comprises:

a wireless transmission unit electrically connected to the central processing unit, and the modem is externally connected to a peripheral device via the wireless transmission unit.

The wireless transmission unit is a Bluetooth transmission unit, a RF transmission unit, an infrared transmission unit, or a Wi-Fi Direct transmission unit.

The first network connector is a RJ-11 connector; the second network connector is a RJ-45 connector.

The signal output port is a high definition multimedia interface connector (HDMI connector) or a mini HDMI connector.

The operating system is Android operating system, iOS operating stem, Windows8 operating system, or Ubuntu operating system.

In order to achieve the above object, a modem with an expansion module is disclosed. The modem comprises:

a first network connector configured to connect to a telephone line, and the modem configured to connect to a telephone socket;

a second network connector configured to connect to a network line, and the modem configured to connect to a computer device via the network line;

a modulation/demodulation module electrically connected to the first network connector and the second network connector, and configured to execute digital and analog conversions and modulation and demodulation operations to network signals; and

an expansion module electrically connected to the modulation/demodulation module, comprising:

a memory unit configured to store an operating system;

a central processing unit electrically connected to the modulation/demodulation module and the memory unit, and configured to execute the operating system after the modem is started up;

a signal output port electrically connected to the central processing unit, and the modem electrically connected to an external display screen via the signal output port; and the signal output port configured to output video and audio signals generated by executing the operating system to the display screen and displayed on the display screen;

a power connector electrically connected to the central processing unit, and the modem connected to a commercial power via the power connector to receive the required power from the commercial power;

a first connector electrically connected to the central processing unit, and the modem externally connected to an input device; and the input device configured to execute the operating system of the expansion module;

a wireless transmission unit electrically connected to the central processing unit, and the modem the modem externally connected to a peripheral device via the wireless transmission unit; and

a switch unit electrically connected to the central processing unit and configured to receive an external trigger to start up the modem;

wherein the expansion module is connected to the modulation/demodulation module to connect to the Internet via the modulation/demodulation module when the central processing unit is configured to execute the operating system.

The first connector is a USB connector, a mini USB connector, or a micro USB connector; the wireless transmission unit is a Bluetooth transmission unit, a RF transmission unit, an infrared transmission unit, or a Wi-Fi Direct transmission unit; the first network connector is a RJ-11 connector and the second network connector is a RJ-45 connector; the signal output port is a high definition multimedia interface connector (HDMI connector) or a mini HDMI connector; the operating system is Android operating system, iOS operating stem, Windows 8 operating system, or Ubuntu operating system.

Comparing to the related art, the present disclosure provides a modem having an expansion module. The modem provides a network connection function. The expansion module can execute an operating system to generate video and audio signals, and the video and audio signals are transmitted to a display screen and displayed on the display screen. Accordingly, it is to significantly reduce manufacturing cost and conveniently store and use by integrating the modem and the expansion module into a casing and by jointly sharing the power supply, the central processing unit, and the heat-dissipating device.

In addition, the expansion module and the modulation/demodulation module are integrated to jointly use the same central processing unit. Accordingly, the expansion module can be connected to the modulation/demodulation module and communicate with the modulation/demodulation module when the central processing unit executes the operating system, so that the user can use the computer device to connect to the Internet via the modulation/demodulation module by executing the operating system. As a result, it is convenient for the user to use the modem as a small computer to connect to the Internet without other network connection devices.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a schematic view of using a modem according to a first embodiment of the present disclosure;

FIG. 2 is a rear view of the modem according to the first embodiment of the present disclosure;

FIG. 3 is a block diagram of the modem according to the first embodiment of the present disclosure;

FIG. 4 is a schematic view of using a modem according to a second embodiment of the present disclosure; and

FIG. 5 is a block diagram of the modem according to the second embodiment of the present disclosure.

### DETAILED DESCRIPTION

Reference will now be made to the drawing figures to describe the present invention in detail.

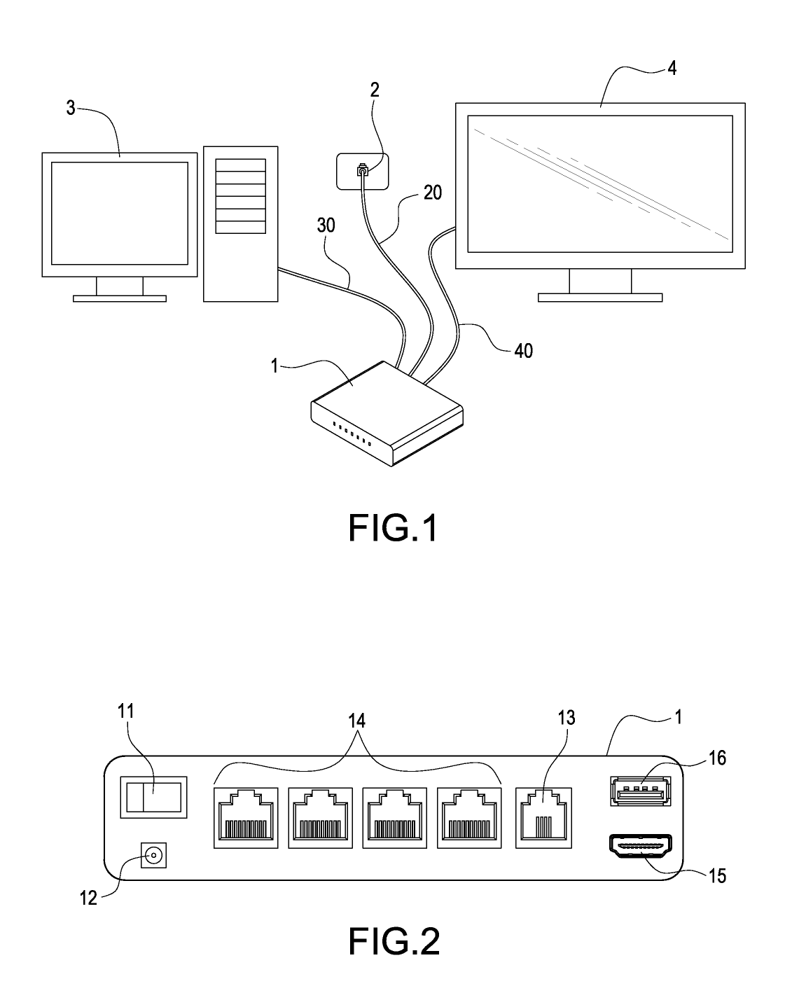

Reference is made to FIG. 1 which is a schematic view of using a modem according to a first embodiment of the present disclosure. As shown in FIG. 1, the present invention discloses a modem with an expansion module (hereinafter referred to as modem 1). The modem 1 is mainly connected to a telephone line 20, and the modem 1 is connected to a telephone socket 2 via the telephone line 20. In addition, the modem 1 is further connected to a network line 30, and the modem 1 is connected to a computer device 3 via the network line 30. Accordingly, the modem 1 is provided to execute digital and analog conversions and modulation and demodulation operations to network signals so that the user can use the computer device 3 to connect to the Internet via the modem 1.

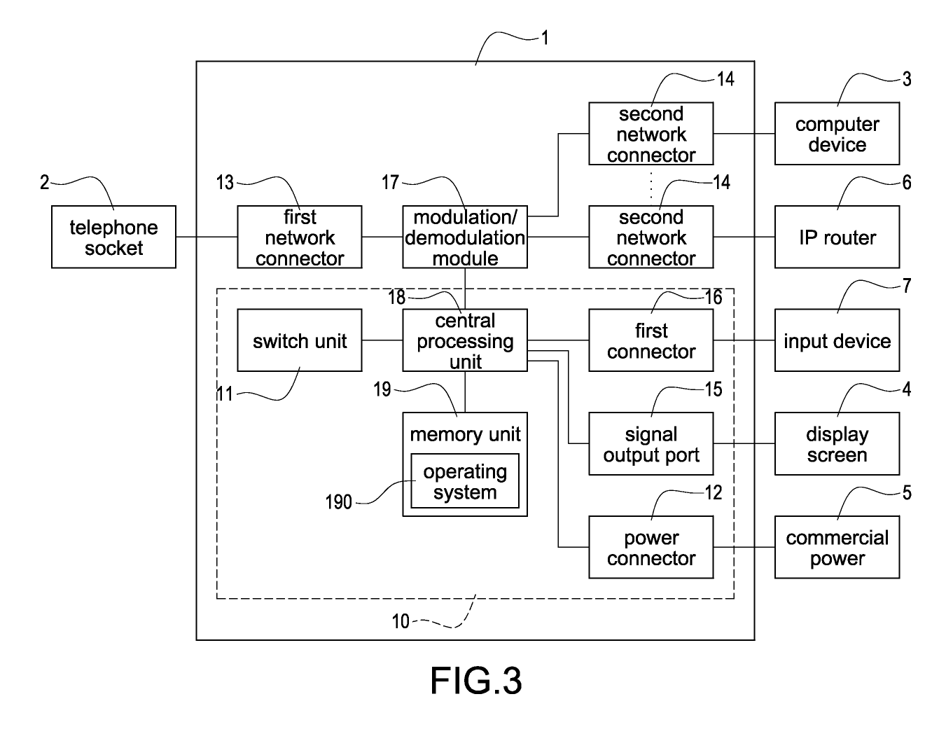

The main technical feature of the present disclosure is that the modem 1 can be connected to one or more than one signal transmission line(s) 40, and connected to an external display screen 4 via the signal transmission line 40. Further, an operating system, such as an operating system 190 shown in FIG. 3, inside the modem 1 can be execute to generate video and audio signals, and the video and audio signals are transmitted via the signal transmission line 40 to the display screen 4 and displayed on the display screen 4. The display screen 4 has a video player unit and an audio player unit (not shown) for playing the video and audio signals transmitted from the modem 1. As a result, the user can directly operate the modem 1 to execute the operating system 190 inside the modem 1 so as to display all execution results on the display screen 4. More specifically, the modem 1 is substantially a small computer.

Reference is made to FIG. 2 which is a rear view of the modem according to the first embodiment of the present disclosure. The modem 1 mainly has a switch unit 11, a power connector 12, a first network connector 13, at least one second network connector 14, at least one signal output port 15, and at least one first connector 16. The modem 1 is connected to a power adapter (not shown) by inserting the power adapter into the power connector 12, thus acquiring the required power through the power adapter. After the modem 1 is supplied power, the user turns on the switch unit 11 to start up the modem 1. Especially, the modulation/demodulation function and the operating system 190 of the modem 1 are executed step by step, or both of them are simultaneously executed by the modem 1.

In present disclosure, the first network connector 13 is mainly a RJ-11 connector for connecting to the telephone line 20, and the modem 1 is connected to the telephone socket 2 via the telephone line 20. The second network connector 14 is mainly a RJ-45 connector for connecting to the network line 30, and the modem 1 is connected to the computer device 3 via the network line 30 so that the user can use the computer device 3 to connect to the Internet via the modem 1.

As shown in FIG. 2, the modem 1 further has the signal output port 15 and the first connector 16. The signal output port 15 is mainly connected to the signal transmission line 40 to transmit the video and audio signals generated by executing the operating system 190, and the video and audio signals are displayed on the display screen 4. Because the modem 1 does not have any operable unit except the switch unit 11, the modem 1 can be connected to an external input device, such as an input device 7 shown in FIG. 7, via the first connector 16 to execute the operating system 190. In this embodiment, one signal output port 15 and one first connector 16 are exemplified for further demonstration. However, the embodiments are only exemplified but are not intended to limit the scope of the disclosure.

In this embodiment, the signal output port 15 is mainly a high definition multimedia interface connector (HDMI connector) or a mini HDMI connector, and more particularly to a female connector, but not limited. The first connector 16 is mainly a universal serial bus connector (USB connector), a mini USB connector, or a micro USB connector, and more particularly to a female connector, but not limited.

Reference is made to FIG. 3 which is a block diagram of the modem according to the first embodiment of the present disclosure. As shown in FIG. 3, the modem 1 further has a modulation/demodulation module 17 and an expansion module 10. The modulation/demodulation module 17 is provided to execute digital and analog conversions and modulation and demodulation operations to network signals. The expansion module 10 is provided to execute the operating system 190 and output the generated video and audio signals.

The modulation/demodulation module 17 is mainly connected to the first network connector 13 and the second network connector 14 to execute digital and analog conversions and modulation and demodulation operations to network signals. When the computer device 3 is connected to the second network connector 14 and the modem 1 is connected to the telephone socket 2 via the first network connector 13, the user can use the computer device 3 to connect to the Internet via the modulation/demodulation module 17 of the modem 1. In addition, the second network connector 14 is further connected to an IP router 6. The IP router 6 can be connected to multiple computer devices (not shown) in wired or wireless manners so that all computer devices can be connected to the Internet via the IP router 6 and the modem 1.

The expansion module 10 mainly has the switch unit 11, the power connector 12, the signal output port 15, the first connector 16, a central processing unit 18, and a memory unit 19. The central processing unit 18 is connected to the switch unit 11, the power connector 12, the signal output port 15, the first connector 16, and the memory unit 19 for processing various commands and signals of the expansion module 10. Especially, the central processing unit 18 is jointly used by the expansion module 10 and the modulation/demodulation module 17 so as to effectively reduce the cost of the modem 1. In other words, the expansion module 10 is electrically connected to the modulation/demodulation module 17 via the central processing unit 18, and the central processing unit 18 is provided to simultaneously process various commands and signals of the expansion module 10 and the modulation/demodulation module 17.

The operating system 190 is stored in the memory unit 19. When the user turns on the switch unit 11 to start up the modem 1, the central processing unit 18 is simultaneously started up to execute the operating system 190 of the memory unit 19. In this embodiment, the operating system 190 can be Android operating system, iOS operating stem, Windows 8 operating system, or Ubuntu operating system. However, the embodiments are only exemplified but are not intended to limit the scope of the disclosure. Especially, the modem 1 is connected to a commercial power 5 by inserting the power adapter into the power connector 12 of the expansion module 10, thus acquiring the required power from the commercial power 5 to the modem 1. The user can turn on the switch unit 11 to start up the modem 1 after the power connector 12 is connected to the commercial power 5. In addition, if the commercial power 5 is unavailable, the power connector 12 can be directly connected to other power supply devices, such as portable powers or batteries, to acquire the required power to supply the modem 1.

As shown in FIG. 3, the expansion module 10 is connected to the display screen 4 via the signal output port 15, and further connected to the input device 7 via the first connector 16. Accordingly, the user can operate the input device 7 to execute the operating system 190 by the central processing unit 18 after the modem 1 is started up so that the video and audio signals are transmitted to the display screen 4 and displayed on the display screen 4 via the signal output port 15 of the expansion module 10.

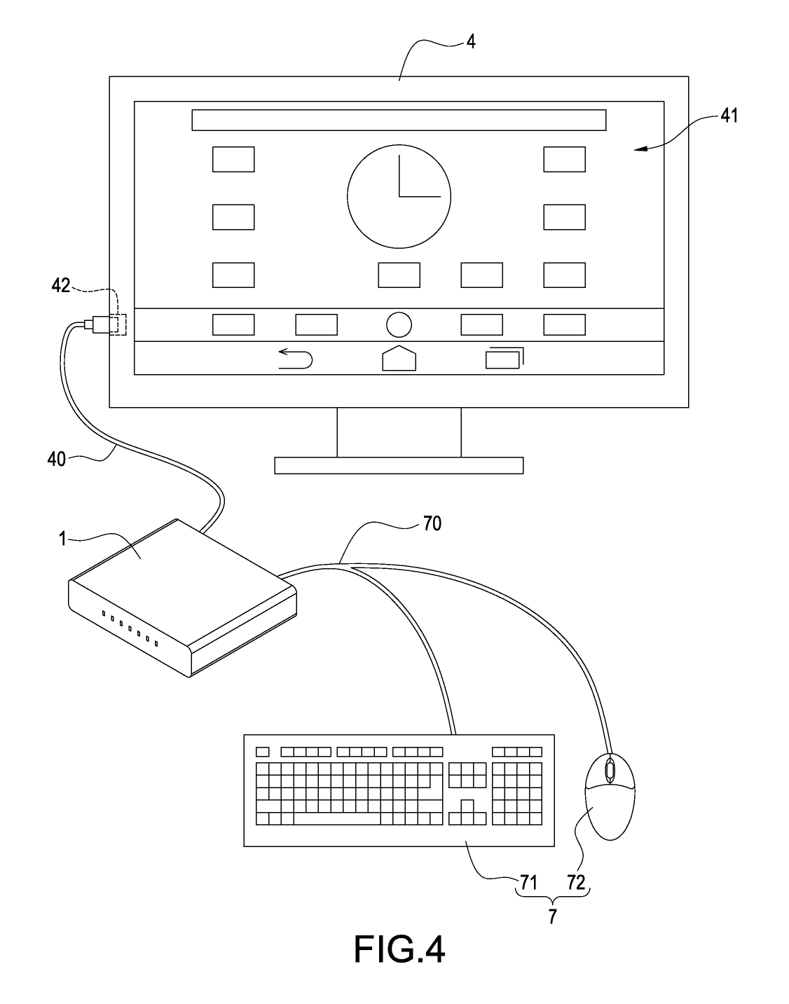

Reference is made to FIG. 4 which is a schematic view of using a modem according to a second embodiment of the present disclosure. The modem 1 is connected to the input device 7 via the first connector 16 of the expansion module 10. In particular, the input device 7 can be a device with an input function, such as a keyboard 71 or a mouse 72, and the input device 7 is connected to the first connector 16 via one or more than one transmission line(s) 70. The modem 1 is further connected to the display screen 4 via the signal output port 15 of the expansion module 10. More specifically, the signal output port 15 is a female connector which is inserted into one terminal of the signal transmission line 40, and the other terminal of the signal transmission line 40 is inserted into a female connector 42 corresponding to the display screen 4. In this embodiment, the signal output port 15 and the female connector 42 are HDMI connectors or mini HDMI connectors, and the signal transmission line 40 is a HDMI transmission line or a mini HDMI transmission line. However, the embodiments are only exemplified but are not intended to limit the scope of the disclosure.

As shown in FIG. 4, an execution frame 41 generated from the operating system 190 is outputted to the display screen 4 and displayed on the display screen 4 after the operating system 190 is executed by the expansion module 10 and the expansion module 10 is connected to the display screen 4. In this embodiment, a main frame of Android operating system is exemplified as the execution frame 41, but not limited. The user can use the modem 1 as a small computer to execute the operating system 190 via the input device 7 and the display screen 4.

Especially, the expansion module 10 and the modulation/demodulation module 17 are integrated to jointly use the same central processing unit 18. Accordingly, the expansion module 10 can be connected to the modulation/demodulation module 17 and communicate with the modulation/demodulation module 17 when the central processing unit 18 executes the operating system 190, so that the user can use the computer device 3 to connect to the Internet via the modulation/demodulation module 17 by executing the operating system 190. As a result, it is convenient for the user to use the modem 1 as a small computer to connect to the Internet without other network connection devices.

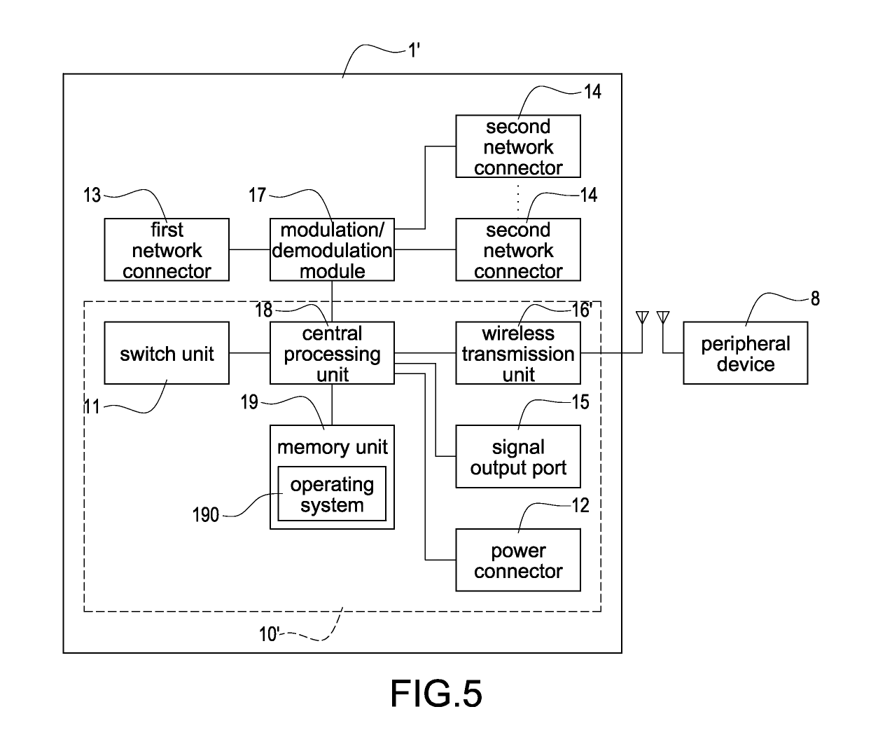

Reference is made to FIG. 5 which is a block diagram of the modem according to the second embodiment of the present disclosure. In this embodiment, another modem 1′ is disclosed. The major difference between the modem 1′ and the above-mentioned modem 1 is that the modem 1′ has another expansion module 10′ having a wireless transmission unit 16′ which is electrically connected to the central processing unit 18. The technical feature of this embodiment is that the expansion module 10′ can establish connections to one or more than one peripheral device(s) 8 via the wireless transmission unit 16′ for the user to operate. In particular, the peripheral device 8 can be a wireless AP, a Wi-Fi HDD, a Bluetooth ear-hook headphone or speaker. However, the embodiments are only exemplified but are not intended to limit the scope of the disclosure. In addition, the user can use a wireless input device, such as the wireless keyboard, the wireless mouse, or the infrared remote controller to execute the operating system 190 via the wireless transmission unit 16′. Comparing to the wired input device 7, the wireless transmission unit 16′ is provided for the user to flexibly use the modem 1′.

In this embodiment, the wireless transmission unit 16′ can be a Bluetooth transmission unit, a RF transmission unit, an infrared transmission unit, or a Wi-Fi Direct transmission unit. However, the embodiments are only exemplified but are not intended to limit the scope of the disclosure. Especially, the user can use either the modem 1 with the first connector 16 or the modem 1′ with the wireless transmission unit 16′, or use the modem 1 with both the first connector 16 and the wireless transmission unit 16′. Further, the expansion module 10 can be connected to the input device 7 and the peripheral device 8 to provide comprehensive functions.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A modem with an expansion module, comprising:
a first network connector configured to connect to a telephone line, and the modem configured to connect to a telephone socket;
a second network connector configured to connect to a network line, and the modem configured to connect to a computer device via the network line;
a modulation/demodulation module electrically connected to the first network connector and the second network connector, and configured to execute digital and analog conversions and modulation and demodulation operations to network signals; and
an expansion module electrically connected to the modulation/demodulation module, comprising:
a memory unit configured to store an operating system;
a central processing unit electrically connected to the modulation/demodulation module and the memory unit, and configured to execute the operating system after the modem is started up;
a signal output port electrically connected to the central processing unit, and the modem electrically connected to an external display screen via the signal output port; and the signal output port configured to output video and audio signals generated by executing the operating system to the display screen and displayed on the display screen;
a power connector electrically connected to the central processing unit, and the modem connected to a commercial power via the power connector to receive the required power from the commercial power; and
a switch unit electrically connected to the central processing unit and configured to receive an external trigger to start up the modem;
wherein the expansion module is connected to the modulation/demodulation module to connect to the Internet via the modulation/demodulation module when the central processing unit is configured to execute the operating system.

2. The modem with the expansion module in claim 1, further comprising:
a first connector electrically connected to the central processing unit, and the modem is externally connected to an input device via the first connector; wherein the input device is configured to execute the operating system of the expansion module.

3. The modem with the expansion module in claim 2, wherein the first connector is a USB connector, a mini USB connector, or a micro USB connector.

4. The modem with the expansion module in claim 1, further comprising:
a wireless transmission unit electrically connected to the central processing unit, and the modem is externally connected to a peripheral device via the wireless transmission unit.

5. The modem with the expansion module in claim 4, wherein the wireless transmission unit is a Bluetooth transmission unit, a RF transmission unit, an infrared transmission unit, or a Wi-Fi Direct transmission unit.

6. The modem with the expansion module in claim 1, wherein the first network connector is a RJ-11 connector; the second network connector is a RJ-45 connector.

7. The modem with the expansion module in claim 6, wherein the signal output port is a high definition multimedia interface connector (HDMI connector) or a mini HDMI connector.

8. The modem with the expansion module in claim 7, wherein the operating system is Android operating system, iOS operating stem, Windows 8 operating system, or Ubuntu operating system.

9. A modem with an expansion module, comprising:
a first network connector configured to connect to a telephone line, and the modem configured to connect to a telephone socket;
a second network connector configured to connect to a network line, and the modem configured to connect to a computer device via the network line;
a modulation/demodulation module electrically connected to the first network connector and the second network connector, and configured to execute digital and analog conversions and modulation and demodulation operations to network signals; and
an expansion module electrically connected to the modulation/demodulation module, comprising:
a memory unit configured to store an operating system;
a central processing unit electrically connected to the modulation/demodulation module and the memory unit, and configured to execute the operating system after the modem is started up;
a signal output port electrically connected to the central processing unit, and the modem electrically connected to an external display screen via the signal output port; and the signal output port configured to output video and audio signals generated by executing the operating system to the display screen and displayed on the display screen;
a power connector electrically connected to the central processing unit, and the modem connected to a commercial power via the power connector to receive the required power from the commercial power;
a first connector electrically connected to the central processing unit, and the modem externally connected to an input device; and the input device configured to execute the operating system of the expansion module;
a wireless transmission unit electrically connected to the central processing unit, and the modem the modem externally connected to a peripheral device via the wireless transmission unit; and
a switch unit electrically connected to the central processing unit and configured to receive an external trigger to start up the modem;
wherein the expansion module is connected to the modulation/demodulation module to connect to the Internet via the modulation/demodulation module when the central processing unit is configured to execute the operating system.

10. The modem with the expansion module in claim 9, wherein the first connector is a USB connector, a mini USB connector, or a micro USB connector; the wireless transmission unit is a Bluetooth transmission unit, a RF transmission unit, an infrared transmission unit, or a Wi-Fi Direct transmission unit; the first network connector is a RJ-11 connector and the second network connector is a RJ-45 connector; the signal output port is a high definition multimedia interface connector (HDMI connector) or a mini HDMI connector; the operating system is Android operating system, iOS operating stem, Windows 8 operating system, or Ubuntu operating system.
